(19) United States
(12) Patent Application Publication
(10) Pub. No.: US 2007/0091859 A1
(43) Pub. Date: Apr. 26, 2007

(54) System and method for association of mobile units with an access point

(76) Inventors: Aseem Sethi, Bangalore (IN); Naresh Sunkara, Bangalore (IN); Amit Phadnis, Bangalore (IN)

Correspondence Address: FAY KAPLUN & MARCIN, LLP, 15O BROADWAY, SUITE 702, NEW YORK, NY, 10038, US

(21) Appl. No.: 11/258,809

(22) Filed: Oct. 26, 2005

(51) Int. Cl. H04Q 7/24

(52) U.S. Cl. 370/338

(57) ABSTRACT

Described is a method and system for association of mobile units (“MU”) with an access point (“AP”). Each AP transmits a beacon signal within a corresponding coverage area, each beacon signal including a subnet of Internet Protocol (“IP) addresses being served by the AP transmitting the beacon signal. The MU associates with a first one of the APs and obtaining an IP address from the subnet served by the first AP. When the MU leaves the coverage area of the first AP, the MU receives beacon signals from other ones of the APs and associates with a second AP based on the second AP serving the subnet served by the first AP.

### BACKGROUND INFORMATION

The implementation of comprehensive wireless networks has increased the productivity, efficiency and mobility of workers. Moreover, organizations can easily provide wireless coverage where network connections were not previously available without much effort. With a wireless-enabled mobile unit (“MU”), wireless networks based on, for example, the IEEE 802.11x standard, have allowed people to access communications networks such as the internet at work, school, etc, without the hassles of carrying cables and finding a network drop location. These wireless networks also allow the user to move locations and remain connected to the network. This allows the user to preserve any work that the user had be performing and also to keep any connections and/or programs from the network running.

Although wireless networks allow users a level of mobility that was not previously available, the ability to roam throughout areas where a wireless network is available while preserving the network connection is not entirely seamless. Some wireless networks may have been designed into smaller “pieces” called subnets. This type of network may be implemented for reasons of network management, subnet-specific service, etc. When a MU is trying to obtain a network connection wirelessly, it finds a wireless access point (“AP”) servicing its area. It next sends an association request packet, and after the AP has authenticated the user (e.g. user name, password, etc) and may run some further management algorithms, it assigns the MU an internet protocol (“IP”) address. This may be done by the network administrator, or by a dynamic host configuration protocol (“DHCP”) server. In the situation that a DHCP server is used to allocate IP addresses to the MUs, each AP may have a subnet of IP addresses from which to choose and give to a MU. However, when a user of a MU is roaming through different areas of a wireless network, it may become necessary to associate with a different AP. This situation may arise if the new location of the MU is out of the range of the original AP. In this situation, if the new AP has a different subnet than the original AP, then it will be necessary for the MU to re-associate with the new AP, and have the DHCP allocate a new IP address. This will cause time to be wasted in obtaining a new IP address, and may also cause any work that the user of the MU may have been performing on the network, or any connections to network-vital programs to be lost, thus having an adverse effect on efficiency and productivity.

### SUMMARY OF THE INVENTION

The present invention relates to a method and system for association of mobile units (“MU”) with an access point (“AP”). Each AP transmits a beacon signal within a corresponding coverage area, each beacon signal including a subnet of Internet Protocol (“IP) addresses being served by the AP transmitting the beacon signal. The MU associates with a first one of the APs and obtaining an IP address from the subnet served by the first AP. When the MU leaves the coverage area of the first AP, the MU receives bacon signals from other ones of the APs and associates with a second AP based on the second AP serving the subnet served by the first AP.

### BRIEF DESCRIPTION OF THE DRAWINGS

FIG. 1 is an exemplary embodiment of a system according to the present invention; and

FIG. 2 is an exemplary embodiment of a method according to the present invention.

### DETAILED DESCRIPTION

The present invention may be further understood with reference to the following description and the appended drawings. The present invention provides a system and a method for re-associating wireless-enabled mobile units (“MUs”) to wireless access points (“APs”) based on the subnets that the APs are serving. Although the present invention will be described with reference to a IEEE 802.11x wireless network with dynamic host configuration protocol (“DHCP”) servers for allocating internet protocol (“IP”) addresses, it will be understood by those of skill in the art that the present invention may be used with any wireless network that requires a dynamic allocation of addresses to its MUs. Moreover, these addresses are not limited to IP addresses, but may be any addresses which require dynamic allocation.

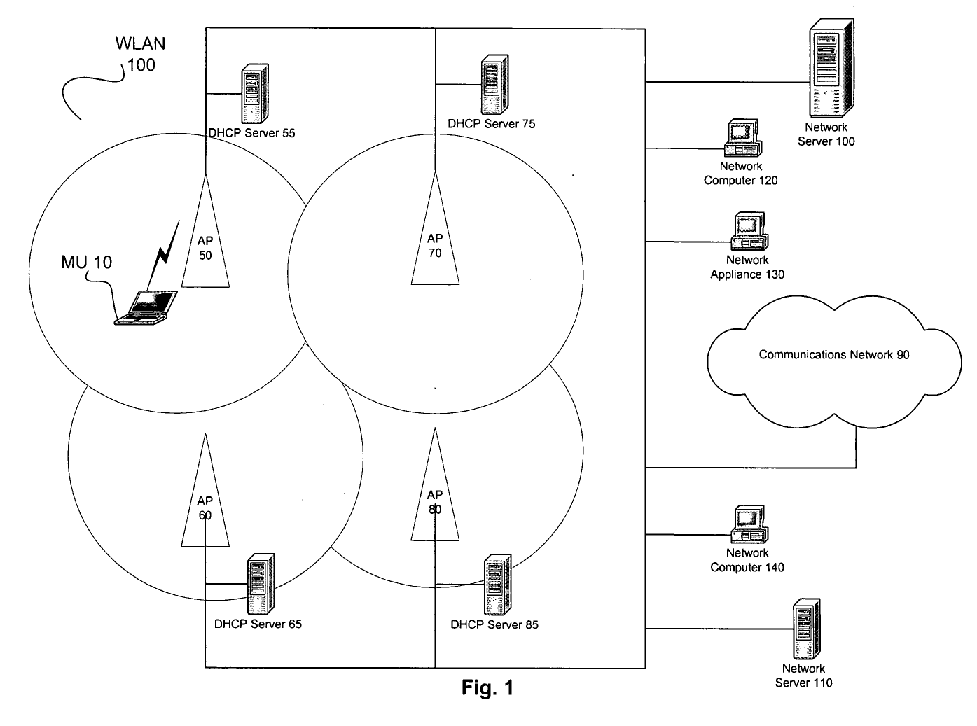

FIG. 1 shows an exemplary embodiment of a wireless network. This embodiment uses a wireless local area network (“WLAN”) 100 such as a IEEE 802.11x wireless network. However, those of skill in the art will understand that the present invention may be implemented on any wireless network. The WLAN 100 may include a plurality of access points (“AP”s) 50, 60, 70 and 80. The WLAN 100 may also include a wireless-enabled mobile units (“MU”s) 10. These MUs may include cell phones, pagers, personal data assistants (“PDAs”), laptop computers, mobile computing devices, etc. The APs 50, 60, 70 and 80 may be connected to a wired portion of a network. The wired portion of the network may include a plurality of network devices such as network servers, network appliances, etc. FIG. 1 shows a plurality of exemplary network devices 100-140. This example also shows DHCP servers 55-85 as being included as part of the wired portion of the network. Each AP 50-80 has a corresponding DHCP server 55-85. In an alternative embodiment, one or more DHCP servers may serve multiple APs. In a further alternative embodiment, the APs 50-80 may have onboard DHCP servers. Those of skill in the art will understand that the location and the number of DHCP servers is irrelevant for the implementation of the present invention.

In addition, the wired portion of the network may be connected to communications network 90, such as an organization's intranet, the Internet, etc. The communications network 90 and associated connection may include infrastructure such as routers, switches, servers, gateways, firewalls, etc. Thus, the MU 10, via the APs 50-80, may be connected to the communications network 90.

As shown in FIG. 1, each of the APs 50-80 has a corresponding coverage area. The APs 50-80 may communicate with the MUs in their corresponding coverage area. In this example, the AP 50 provides a wireless connection for the MU 10, e.g., the MU 10 has associated with the AP 50, and has obtained an IP address through the AP 50. The allocation of the IP address may have been performed by a network administrator, by the DHCP server 55 associated with the AP 50, a separate DHCP server, etc. Prior to allocating an IP address for the MU 10, the AP 50 may have executed some management and authentication algorithms (e.g., password, user, bandwidth allocation, channel allocation, etc). As described above, this exemplary embodiment will use the situation where each of the APs has a dedicated DHCP server. Each DHCP server 55-85 serves a defined subnet, which contains information regarding the range of IP addresses that it has available to allocate to an MU, and thus service with a wireless network connection. Some APs, such as Symbol Technology's WS2000™, can service multiple subnets simultaneously. When the MU 10 initially attempts to connect to the APs 50, 60, 70 or 80, an IP address will be allocated to the MU 10 via the corresponding DHCP server 55-85. After associating with the AP 50, 60, 70 or 80, the MU 10 may have full access to the network and the communications network 90.

While the MU 10 remains within the coverage area of the AP 50 with which it has initially associated, the MU 10 will be free to roam as far as the coverage area of the AP 50. There should be no disruptions in service from having to re-associate with a different AP since the MU 10 would be serviced by the AP 50 throughout the entire coverage area of the AP 50. However, a problem may arise if the user of the MU 10 needed to move out of the coverage area of the AP 50. As seen in FIG. 1, this situation may arise if the user of the MU 10 changes his/her location so that the MU 10 is no longer within the coverage area of the AP 50, but rather within the coverage area of the AP 60, 70 or 80. Traditionally, once an MU leaves the coverage area of an AP with which it is associated, it will automatically search for any AP within range, and arbitrarily connect with that AP, regardless of the subnets that the AP is servicing. The situation may arise where the new AP with which the MU is associating may not be servicing the same subnet as the original AP. This would cause the MU to interact with the DHCP server associated with the new AP each time it needed to re-associate, leading to down time and a loss of productivity.

The exemplary embodiments of the present invention cure the loss of productivity of the MU having to interact with the corresponding DHCP server each time it needs to re-associate with a new AP. As seen in FIG. 1, the MU 10 may need to roam out of the coverage area of the AP 50 and a coverage area of any one of the AP 60, 70, or 80. At this point, the MU 10 may begin receiving the beacon transmissions from the APs 60, 70 and 80. The exemplary embodiment of the present invention includes additional data in the traditional beacon packet that an AP may transmit. This additional data notifies the MU 10 of the subnet that each of the APs 60, 70 and 80 is servicing. This may be performed by, for example, transmitting the subnet mask that each of the APs are applying in allocating IP addresses. Those skilled in the art will understand that this data may be transmitted in any number of methods and/or implementations.

As the MU 10 is attempting to re-associate with a new (depending on the respective coverage areas) AP 60, 70 or 80, it may receive each AP's respective beacon containing the data referring to the subnets that each AP is servicing. The MU 10 would then be able to choose to associate with the AP that was servicing the same subnet as the AP 50. This would allow the MU 10 to maintain the IP address that it had received from the AP 50, but associate with the new AP.

In one example, the AP 50 is servicing subnet A, the AP 60 is servicing subnet B, the AP 70 is servicing subnet A, and the AP 80 is servicing subnet B. As the MU 10 leaves the coverage area of the AP 50, and enters a location within the coverage area of the APs 60, and 70, the MU 10 may receive the beacon packets of each of the APs 60 and 70 and determine that the AP 70 is servicing the same subnet as the AP 50. The MU 10 would then disregard the AP 60 and associate with the AP 70. This would allow the MU 10 to continue to use the IP address that had been assigned by the DHCP server 55 of the AP 50. This removes the requirement of the MU 10 to interact with the DHCP server 75 of the AP 70 to obtain a new IP address.

This allows the user of the MU 10 to preserve network critical applications (e.g. instant massaging, conferencing, etc) and work being done on the network without requiring a new connection, thus saving time and maintaining productivity and efficiency. If the WLAN 100 were implemented with Symbol Technology's WS2000™ model wireless access point (or similar APs) which can support multiple subnets, the present invention would allow the MU 10 to request association with whichever subnet it had been previously associated with through the AP 50. This may be done by placing a corresponding subnet ID in the message sent from the MU 10 to the AP with which it desires to associate.

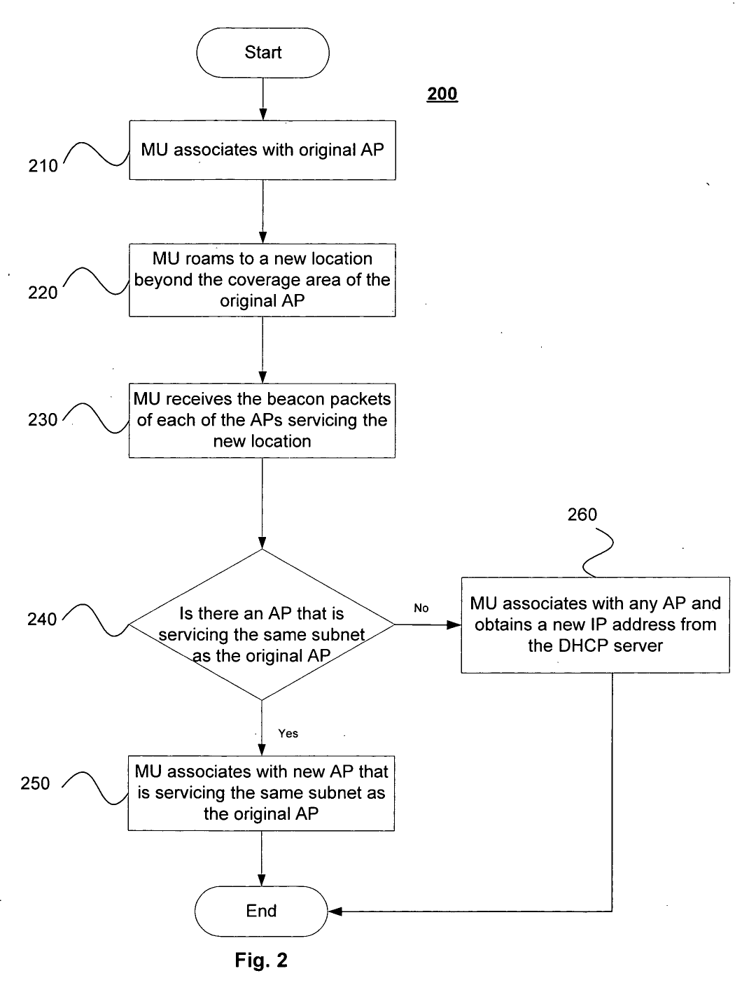

FIG. 2 shows a method according to the exemplary embodiment of the present invention that allows an MU to re-associate with an AP based on the subnets served by the AP in a wireless network. The method is described with reference to the network described in FIG. 1. Those of skill in the art will understand that other systems having various configurations may be used to execute the exemplary method.

In step 210, an MU (e.g. MU 10) associates with and communicates through an AP (e.g. AP 50). As part of this association, the MU 10 obtains an IP address from the corresponding DHCP server 55 of the AP 50. The MU 10 is then free to roam throughout the coverage area of the AP 50 and not face any problems of having to associate with a new AP. While in the coverage area of the AP 50, the MU 10 may communicate, for example, with the communications network 90 using the assigned IP address.

In step 220, the MU 10 roams to a new location beyond the coverage area serviced by the AP 50. Since the MU 10 has roamed to a location outside the coverage area of the AP 50, the MU 10 will need to associate with an AP other than the AP 50 in order to have a connection to the wireless network. In the exemplary embodiment, the new location to which the MU 10 may have roamed may be serviced by one or more of the APs 60, 70, and 80. The MU 10 may be able to associate with any of the three APs found servicing this location.

In step 230, the MU 10 may receive the beacon packets of each of the APs servicing its new location. These bacon packets will contain information advising the MU 10 as to which subnets each AP is servicing. This may be performed by transmitting the subnet mask that each of the APs are utilizing. Traditionally, beacon packets are transmitted by APs so that MUs will be able to associate with a given AP. These beacon packets contain basic information regarding the wireless network such as the service set identifier (“SSID”), channel, whether it is encrypted, etc. However, in the exemplary embodiment of the present invention, additional data will be included in this beacon packet alerting MUs looking to associate with an AP the subnet that each AP is serving. This may be performed by transmitting the subnet masks available to each AP. Although these beacon packets may be standardized according to the wireless network standard on which the AP is operating (e.g. 802.11a, 802.11b, etc), those skilled in the art will understand that the information regarding the subnet being serviced can be appended onto the beacon packets in a variety of methods.

In step 240, the MU 10 may take the data regarding the subnets from each of the APs received in each of the beacon packets, and compare each of the subnets to the IP address that it had received from the DHCP server 55 of the AP 50. Determining whether or not one of the new APs that is servicing the area is servicing the same subnet as the AP 50 may lead to increased efficiency and productivity. Thus, the MU 10 will assess the data regarding the subnets serviced by the APs 60, 70 and 80, and determine whether or not any of them is servicing the same subnet as the AP 50.

In step 250, if the MU 10 has determined that one of the APs 60, 70 or 80 is servicing the same subnet as the AP 50, then the MU will associate with the selected AP. In one exemplary embodiment, if the AP 50 is servicing subnet A, the AP 60 is servicing subnet B, the AP 70 is servicing subnet C, and the AP 80 is servicing subnet A, then the MU 10 would select the AP 80. The MU 10 would then associate with the AP 80. Selecting the “new” AP based on subnets allows the MU 10 to save time by not having to interact with the DHCP server of the new AP to obtain a new IP address. Since the AP 80 is servicing the same subnet as the AP 50, the MU 10 would be able to maintain the IP address that it had obtained from the AP 50. Moreover, this type of re-association may increase productivity dealing with any network critical applications (i.e. instant messaging, conferencing software, etc) since the IP address would be preserved and a new connection may not need to be formed. This would increase the productivity in possibly eliminating some downtime of such applications.

In step 260, if none of the APs 60, 70 or 80 is servicing the same subnet as the AP 50, the subnets of the APs 60, 70 and 80 become irrelevant. Whichever AP the MU 10 associates with, the MU 10 may have to interact with the corresponding DHCP server and obtain a new IP address. In this given scenario, the MU 10 will associate with one of the APs 60, 70 or 80, and will interact with the corresponding DHCP server to obtain a new IP address.

As described above, the present invention has been described with reference to a DHCP server assigning IP addresses from a subnet to MUs. However, it will be apparent to those of skill in the art that the present invention may be implemented in any dynamic address allocation scheme, whereby different APs may serve overlapping addresses and it would be advantageous to save time and resources by not having to re-allocate a new address to the MU.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A method comprising:
associating a mobile unit (“MU”) with a first access point (“AP”) in a first coverage area, wherein the association includes receiving an address from the first AP, wherein the address is included in a first subset of addresses;
receiving a plurality of beacon signals corresponding to a plurality of further APs in a second coverage area, wherein each beacon signal includes an indication of a subset of addresses served by each further AP;
selecting a second AP from the plurality of APs based on the second AP serving the first subset; and
re-associating with the second AP.

2. The method of claim 1, wherein the address is an IP address.

3. The method of claim 1, wherein the subsets are subnets.

4. The method of claim 1, wherein the mobile unit includes one of a laptop, a personal data assistant (“PDA”), a handheld computer and a mobile computing device.

5. The method of claim 2, wherein the IP address is assigned by a dynamic host configuration protocol (“DHCP”) server.

6. The method of claim 3, wherein the indication of a subnet includes a subnet mask.

7. A system comprising:
a plurality of access points (“AP”), each access point transmitting a beacon signal within a corresponding coverage area, each beacon signal including a subnet of Internet Protocol (“IP) addresses being served by the AP transmitting the beacon signal; and
a mobile unit (“MU”) associating with a first one of the APs and obtaining an IP address from the subnet served by the first AP, wherein, when the MU leaves the coverage area of the first AP, the MU receives beacon signals from other ones of the APs and associates with a second AP based on the second AP serving the subnet served by the first AP.

8. The system of claim 7, wherein the MU is one of a laptop, personal data assistant (“PDA”), a handheld computer and a mobile computing device.

9. The system of claim 7, further comprising:
a dynamic host configuration protocol (“DHCP”) server allocating the IP addresses to each of the APs.

10. The system of claim 9, wherein the DHCP server is onboard the AP.

11. The system of claim 7, wherein the beacon signal is an extended IEEE 802.11x beacon signal.

12. The system of claim 7, wherein at least one AP serves multiple subnets and the multiple subnets are identified in the corresponding beacon signal.

13. A mobile unit (“MU”), comprising:
a receiver to receive beacon signals from access points (“AP”), wherein the beacon signal from each AP includes an indication of a subnet the AP is serving; and
a comparison module to compare a subnet with which the MU is currently associated to the subnets included in each of the received beacon signals; and
an association module to generate an association signal for the MU to associate with an AP that is serving the subnet with which the MU is currently associated.

14. The mobile unit of claim 13, wherein each subnet includes a plurality of IP addresses.

15. The mobile unit of claim 14, wherein the MU is assigned one of the IP addresses from the subnet with which the MU is currently associated.

16. The mobile unit of claim 13, wherein the MU is one of a laptop, personal data assistant (“PDA”), a handheld computer and a mobile computing device.

17. The mobile unit of claim 13, wherein the receiver is a transceiver that further sends the association signal to the AP that is serving the subnet with which the MU is currently associated.

18. The mobile unit of claim 15, wherein the mobile unit uses the IP address to communicate with devices on a communications network.

19. The mobile unit of claim 18, wherein the communications network is the Internet.
